(19) United States
(12) Patent Application Publication
(10) Pub. No.: US 2009/0327702 A1
(43) Pub. Date: Dec. 31, 2009

(54) Key Escrow Service

(75) Inventor: Patrik Schnell, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/163,681

(22) Filed: Jun. 27, 2008

(51) Int. Cl. H04L 9/32; G06F 21/00; H04L 9/00; H04L 9/08

(52) U.S. Cl. 713/155; 726/26; 713/175; 713/168; 380/286

(57) ABSTRACT

A key escrow service is described. In embodiment(s), the key escrow service maintains an escrow license that includes an escrow content key that is associated with protected media content which is distributed from a content distributor to a media device. A content key that is associated with the protected media content can be received from the content distributor, and the content key can then be encrypted with a public escrow key to generate the escrow content key. The escrow license can be generated to include the escrow content key, and the escrow content key can then be communicated back to the content distributor that provides a digital rights management (DRM) license to the media device. The DRM license can include both the escrow content key and the content key encrypted with a public key that corresponds to the media device.

### BACKGROUND

Users can enjoy media content purchased on a physical media, such as songs purchased on a CD (compact disc) or a movie purchased on a DVD (digital versatile disc). Users often buy the media content on physical media and have come to expect that they can enjoy the content when they want and as often as they want. Further, users have grown accustomed to the implicit benefits of buying media content on a CD or DVD. For example, a user can lend a movie or CD to a friend, or enjoy the content on whatever device they have that can play and/or display it. A user can play a CD in their home, in their car, or in a portable device simply by moving the CD from one player to another.

More recently, users are able to access and/or obtain media content digitally, such as through subscription and pay-per-view services. These services have benefits, but also disadvantages over buying content on physical media. The advantages include more-flexible ways to pay and use content, such as accessing content for a period of time when subscribing to a service that allows playing a particular song on an MP3 player for a set number of days. A user can also pay to download media content a certain number of times, such as when “buying” a song to have a right to download it to a computer and then record/transfer it to other devices or storage a limited number of times. In another example, a user can order an on-demand movie and pay once to view the movie, such as at home. However, some content distribution services do not permit users to enjoy media content in the ways in which they have grown accustomed. Someone who, in the past, could buy a song on CD and play it on any CD player that she, a family member, or a friend owns, often cannot do so using these services.

Media content that is available from a content distribution service is licensed for security and to protect it from unauthorized sharing, copying, and/or distribution of the media content. Digital rights to restrict the use of media content can be in the form of a license that also requires a security token to be available for the license to be useful. Typically, the digital rights for media content are bound to a security token, such as a playback device or a component of the device. However if a security token is lost, or if identities corresponding to the security token change over time, then a license for the digital rights would need to be reissued for a user to play or view media content that has already been purchased. This is contrary to a consumers notion that the media content has been “purchased”, and is not just merely “leased” or subject to an expiration.

Some consumers that purchase media content which is protected by a digital rights management policy may find that a content distribution service has gone out of business, and the media content can no longer be played back, or otherwise consumed. Typically this is caused when a digital rights license expires or when a computer that maintains a local copy of the digital rights license stops functioning. A content distribution service issues a license that includes a public and a private key pair, and the device that is licensed to playback the media content is issued or has the only private key. Because the content distribution service has gone out of business, there is no way for the consumer to recover the license and reauthorize the media content, and the protected media content is no longer recognized as having been purchased.

### SUMMARY

This summary is provided to introduce simplified concepts of a key escrow service. The simplified concepts are further described below in the Detailed Description. This summary is not intended to identify essential features of the claimed subject matter, nor is it intended for use in determining the scope of the claimed subject matter.

A key escrow service is described. In embodiment(s), the key escrow service maintains an escrow license that includes an escrow content key that is associated with protected media content which is distributed from a content distributor to a media device. A content key that is associated with the protected media content can be received from the content distributor, and the content key can then be encrypted with a public escrow key to generate the escrow content key. The escrow license can be generated to include the escrow content key, and the escrow content key can then be communicated back to the content distributor that provides a digital rights management (DRM) license to the media device. The DRM license can include both the escrow content key and the content key encrypted with a public key that corresponds to the media device.

In other embodiment(s), the key escrow service maintains an escrow certificate that includes escrow domain key(s) that are associated with a media device registered in a domain. Domain private key(s) can be received from a domain controller of the media device, and the domain private key(s) can then be encrypted with a public escrow key to generate the respective escrow domain key(s). The escrow certificate can be generated to include the escrow domain key(s), and the escrow domain key(s) can then be communicated back to the domain controller that provides a domain certificate to the media device. The domain certificate can include the escrow domain key(s) and a device public key that corresponds to the media device.

### BRIEF DESCRIPTION OF THE DRAWINGS

Embodiments of key escrow service are described with reference to the following drawings. The same numbers are used throughout the drawings to reference like features and components:

FIG. 1 illustrates an example system in which embodiments of a key escrow service can be implemented.

FIG. 2 illustrates another example system in which embodiments of a key escrow service can be implemented.

FIG. 3 illustrates example method(s) for embodiments of a key escrow service.

FIG. 4 illustrates example method(s) for embodiments of a key escrow service.

FIG. 5 illustrates various components of an example device that can implement embodiments of a key escrow service.

### DETAILED DESCRIPTION

Embodiments provide that a key escrow service can maintain or otherwise store an escrow license that includes an escrow content key that is associated with protected media content which is distributed from a content distributor to a media device. The key escrow service can also maintain or otherwise store an escrow certificate that is associated with a media device registered in a domain that is controlled by a domain controller. If the media content service(s) that include the content distributor and/or domain controller go out of business, are no longer in service, or transfer ownership of protected media content to another service, a consumer can recover a digital rights management (DRM) license when the original issuer ceases to operate.

In an example DRM system, various devices can be implemented to perform actions on protected media content as permitted by a DRM license. A device can include any type of portable communication device, music device, television client device, a gaming system, and the like which can perform actions such as to render, playback, copy, print, execute, consume, and/or other actions on the protected media content. The DRM license provides the rights and restrictions of the actions performed on the protected media content.

In an embodiment, a key escrow service can receive a content key that is associated with protected media content from a content distributor, and the content key can then be encrypted with a public escrow key to generate an escrow content key. An escrow license can be generated to include the escrow content key, and the escrow license is stored by the key escrow service. The escrow content key can be communicated back to the content distributor from which the content key was received. The content distributor can then provide a digital rights management (DRM) license to a media device for decryption and playback of protected media content. The DRM license provided by the content distributor includes both the escrow content key generated by the key escrow service, and includes the content key encrypted with a public key that corresponds to the media device.

In an example, a user may replace an older media device with a new one, and want to transfer protected media content and the corresponding license to the new device. If the original provider (i.e., the content distributor) of the protected media content and corresponding license is no longer in service, the key escrow service can receive the DRM license from the new device to request the content key to decrypt the protected media content that has been acquired from the older device. The key escrow service can then correlate the escrow license with the DRM license that is received from the new device, and generate a new license for the new device. The new license includes both the content key encrypted with the escrow content key, and includes the content key encrypted with a public key that corresponds to the new device. The new license can then be communicated to the new device to decrypt the protected media content with the content key.

In another example DRM system, a domain can include multiple devices that each have a private key which is common to the domain. The domain can also include unique certificates associated with a DRM license for each of the multiple devices of the domain. In addition, protected media content can also be bound to the domain such that a device which is a member of the domain having the domain private key and a unique certificate can perform actions on the protected media content that is bound to the domain.

In another embodiment, a key escrow service can receive domain private key(s) from a domain controller of a media device, and the domain private key(s) can then be encrypted with a public escrow key to generate respective escrow domain key(s). An escrow certificate can be generated to include the escrow domain key(s), and the escrow certificate is stored by the key escrow service. A domain certificate can include a domain public key, and optionally, a domain private key (or the domain private key can be delivered to a media device by other techniques). The escrow domain key(s) can be communicated back to the domain controller from which the domain private key(s) were received. The domain controller can then provide a domain certificate to the media device. The domain certificate provided by the domain controller can include the escrow domain key(s) generated by the key escrow service and a device public key that corresponds to the media device.

If the original domain controller of the domain is no longer in service, the key escrow service can receive the domain certificate from a new media device that is being added to the domain, and that is requesting the domain private key(s) to access protected media content that is associated with the domain. The key escrow service can then correlate the escrow certificate with the domain certificate that is received from the new device, and generate a new certificate for the new device. The new certificate can include the one or more domain private key(s) encrypted with the escrow domain key, and a device public key that corresponds to the new device. The new certificate can then be communicated to the new device.

While features and concepts of the described systems and methods for a key escrow service can be implemented in any number of different environments, systems, and/or various configurations, embodiments of a key escrow service are described in the context of the following example systems and environments.

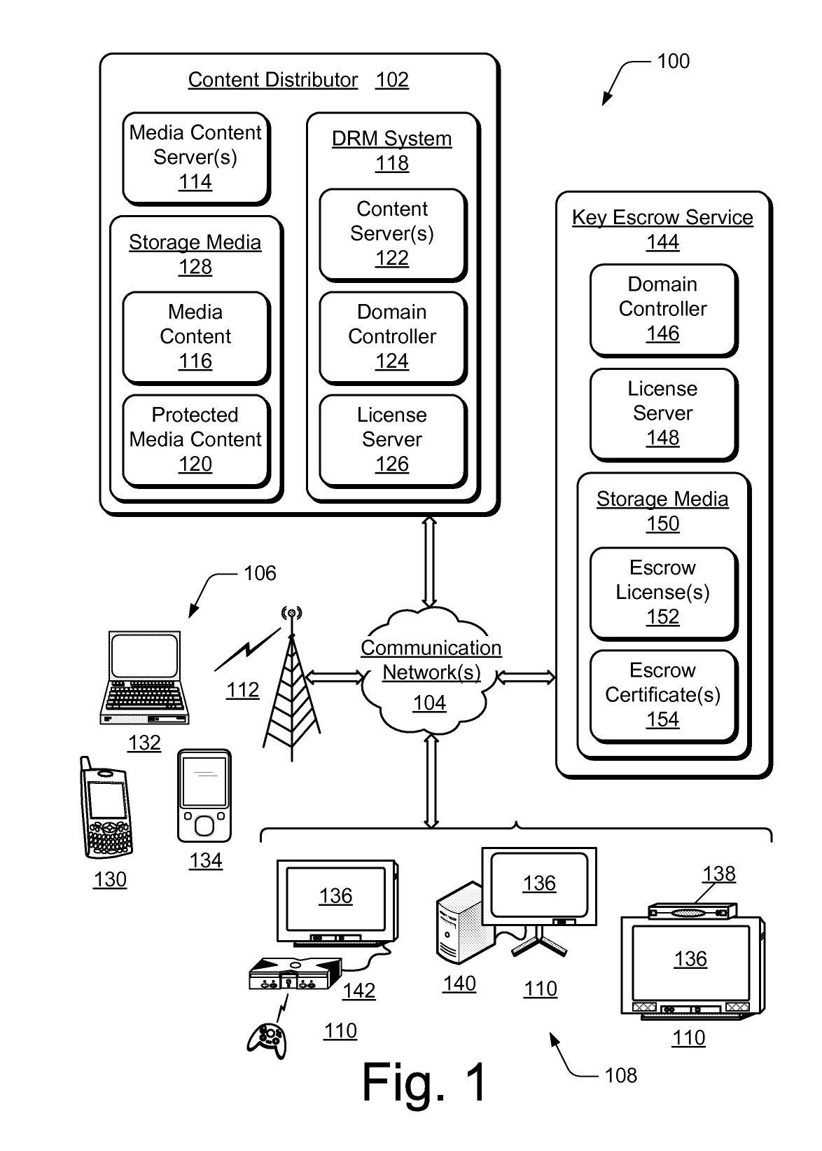

FIG. 1 illustrates an example system 100 in which various embodiments of a key escrow service can be implemented. In this example, system 100 includes a content distributor 102 that communicates or otherwise provides media content to any number of various media devices via communication network(s) 104. The various media devices can include wireless media devices 106 as well as other media devices 108 (e.g., wired and/or wireless client devices) that are implemented as components in various client systems 110. In a media content distribution system, the content distributor 102 facilitates the distribution of media content, protected media content, content metadata, and/or other associated data to multiple viewers, users, customers, subscribers, viewing systems, and devices.

The communication network(s) 104 can be implemented to include any type of data network, voice network, broadcast network, an IP-based network, a wide area network (e.g., the Internet), and/or a wireless communications network 112 that facilitates media content distribution, as well as data and/or voice communications between the content distributor 102 and any number of the various media devices. The communication network(s) 104 can also be implemented using any type of network topology and/or communication protocol, and can be represented or otherwise implemented as a combination of two or more networks. Any one or more of the arrowed communication links facilitate two-way communications, such as from the content distributor 102 to a media device 108 (e.g., a television client device) and vice-versa.

The content distributor 102 can include media content servers 114 that are implemented to receive media content for distribution to subscriber media devices. The content distributor 102 can receive media content 116 from various content sources, such as a content provider, an advertiser, a national television distributor, and the like. The content distributor 102 can communicate or otherwise distribute media content 116 and/or other data to any number of the various wireless media devices 106 and other media devices 108.

The media content 116 (e.g., to include recorded media content) can include any type of audio, video, and/or image media content received from any type of media content source. As described throughout, “media content” can include television programs (or programming), advertisements, commercials, music, movies, video clips, and on-demand media content. Other media content can include interactive games, network-based applications, and any other audio, video, and/or image content (e.g., to include program guide application data, user interface data, advertising content, closed captions data, content metadata, search results and/or recommendations, and the like).

In this example, the content distributor 102 includes a digital rights management (DRM) system 118 that can encrypt the media content 116 to form protected media content 120. The protected media content 120 can include any type of media content that is purchased, downloaded, or otherwise obtained, such as music, a movie, an application, a game, pictures, a video clip, and the like. The DRM system 118 includes content server(s) 122 that distribute the protected media content 120 to the various wireless media devices 106 and other media devices 108. The DRM system 118 also includes a domain controller 124 and a license server 126.

The domain controller 124 can manage device membership in a domain and issue domain certificates and private keys to devices that are members of the domain. The domain controller 124 can maintain a current list of media devices that are part of a particular user's domain, as well as the public and private key pairs that have issued for the domain. The license server 126 can issue DRM licenses which provision the rights and restrictions of actions performed on the protected media content 120 by the various media devices. In an implementation, the domain controller 124 and the license server 126 can be managed by separate entities, or can be implemented together in a domain. Although the content servers 122, domain controller 124, and license server 126 are described as distributed, independent components of the DRM system 118, any one or more of the server(s) and controller(s) can be implemented together as a multi-functional component or entity of the system. In various implementations, domain membership can also be managed by a network operator, a third party entity, or by a user.

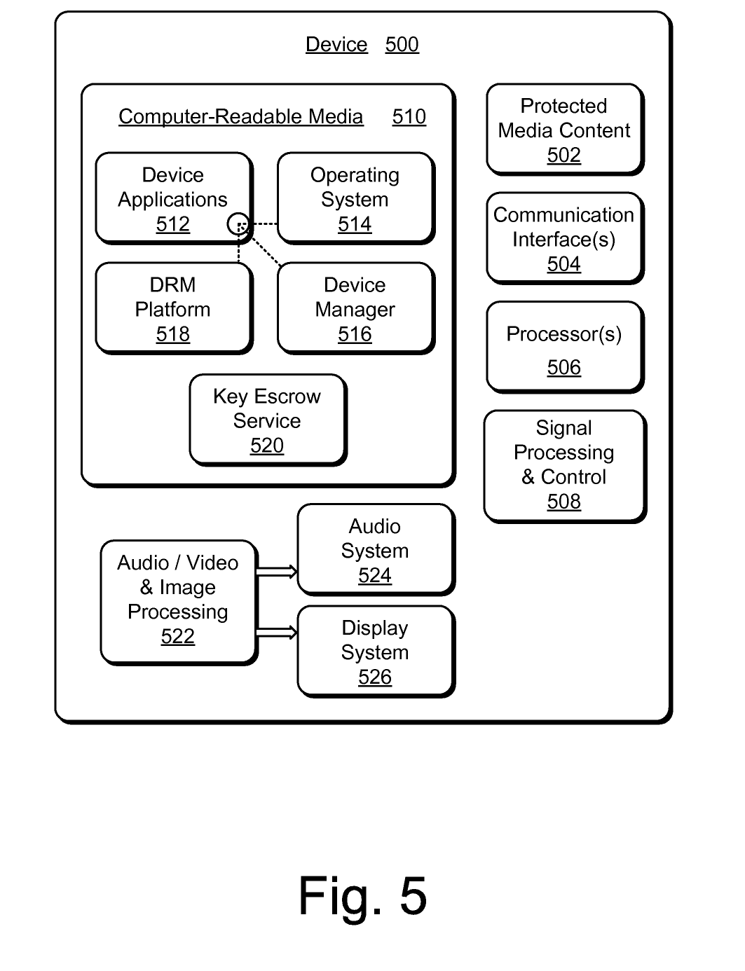

In this example, the content distributor 102 also includes storage media 128 to store or otherwise maintain various data and media content, such as media content 116, protected media content 120, media content metadata, and/or subscriber information. The storage media 128 can be implemented as any type of memory, random access memory (RAM), read only memory (ROM), any type of magnetic or optical disk storage, and/or other suitable electronic data storage. In addition, content distributor 102 can be implemented with any number and combination of differing components as further described with reference to the example device shown in FIG. 5.

The wireless media devices 106 can include any type of device implemented to receive and/or communicate wireless data and voice communications, such as any one or combination of a mobile phone 130 (e.g., cellular, VoIP, WiFi, etc.), a portable computer device 132, a media device 134 (e.g., a personal media player, portable media player, etc.), and/or any other wireless media device that can receive media content in any form of audio, video, and/or image data. Each of the client systems 110 include a respective client device and display device 136 that together render or playback any form of audio, video, and/or image content, media content, protected media content, and/or television content.

A display device 136 can be implemented as any type of a television, high definition television (HDTV), LCD, or similar display system. A client device in a client system 110 can be implemented as any one or combination of a television client device 138 (e.g., a television set-top box, a digital video recorder (DVR), etc.), a computer device 140, a gaming system 142, an appliance device, an electronic device, and/or as any other type of client device that can be implemented to receive television content or media content in any form of audio, video, and/or image data in a media content distribution system.

Any of the wireless media devices 106 and/or other media devices 108 can be implemented with one or more processors, communication components, memory components, signal processing and control circuits, a DRM platform, and a media content rendering system. A media device may also be associated with a user or viewer (i.e., a person) and/or an entity that operates the device such that a media or client device describes logical devices that include users, software, and/or a combination of devices.

The example system 100 also includes a key escrow service 144 that can implement the various embodiments described herein. The key escrow service 144 can be implemented as a third party service apart from the content distributor 102, and can include processors, communication components, memory components, signal processing and control circuits, a DRM platform, and/or computer-executable instructions that are executed by processors to implement the various embodiments of a key escrow service as described herein. In addition, the key escrow service 144 can be implemented with any number and combination of differing components as further described with reference to the example device shown in FIG. 5. In an alternate implementation, the key escrow service 144 can be implemented as a service or system of content distributor 102.

In this example, the key escrow service 144 includes a domain controller 146 and a license server 148. Although not shown, the key escrow service 144 may also include content server(s), as described with reference to the content servers 122 in the DRM system 118. When a media device acquires a license from the license server 126 at content distributor 102, the media device can submit a certificate that is either bound to the device itself or to a domain of which it is a member. The license server 126 can then issue a license with the content key bound to the device, or keys bound to a domain public key contained in the certificate. The keys can be bound to a service specific public key issued by the key escrow service 144 which enables the escrow entity to rebind a license to new media devices that include device bound licenses. For a domain, a domain key history can be escrowed at the key escrow service 144 such that all of the keys in a key history are encrypted to the escrow keys. The escrowed keys can be delivered in the domain certificate and/or stored at the key escrow service with storage media 150. When the licenses are bound to a domain, the domain private keys and associated metadata can be stored in escrow at the key escrow service 144.

In one or more embodiments, the key escrow service 144 can maintain or otherwise store escrow license(s) 152 that each include an escrow content key that is associated with protected media content 120 which is distributed from content distributor 102 to a media device. The key escrow service 144 can also maintain or otherwise store escrow certificate(s) 154 that are each associated with a media device registered in a domain that is controlled by a domain controller 124. If the media content service(s) (e.g., content distributor 102 and/or domain controller 124) go out of business, are no longer in service, or transfer ownership of protected media content to another service, a consumer can recover a digital rights management (DRM) license from the key escrow service 144 when the original issuer ceases to operate.

In an embodiment, the key escrow service 144 can receive a content key that is associated with protected media content 120 from content distributor 102, and license server 148 can encrypt the content key with a public escrow key to generate an escrow content key. The license server 148 can generate an escrow license 152 to include the escrow content key, and the escrow license 152 is stored with storage media 150 by the key escrow service. The escrow content key can be communicated back to the content distributor 102 from which the content key was received. The content distributor 102 can then provide a DRM license to a media device for decryption and playback of protected media content 120. The DRM license provided by the content distributor includes both the escrow content key generated by the key escrow service, and includes the content key encrypted with a public key that corresponds to the media device.

In an example, a user may replace an older media device with a new one, and want to transfer protected media content and the corresponding license to the new device. If the original provider (i.e., content distributor 102) of the protected media content 120 and corresponding license is no longer in service, the key escrow service 144 can receive the DRM license from the new device to request the content key to decrypt the protected media content that has been acquired from the older device. The license server 148 at the key escrow service 144 can then correlate the escrow license 152 with the DRM license that is received from the new device, and generate a new license for the new device. The new license includes both the content key encrypted with the escrow content key, and includes the content key encrypted with a public key that corresponds to the new device. The new license can then be communicated to the new device to decrypt the protected media content with the content key.

In one or more embodiments, the license server 148 at the key escrow service 144 can be implemented to receive the DRM license from the new device as a redirected request from the content distributor 102. For example, the new device may initiate communication of the DRM license to request the content key to the content distributor 102, which may then redirect the request to the key escrow service 144. The key escrow service 144 can also be implemented to authenticate the new media device before responding to the request for the content key. The license server 148 can authenticate the new media device based on DRM properties received as part of the DRM license from the new device. Authentication allows for validation of a consumer for transferability of the rights and restrictions that were part of an original purchase of protected media content.

In another example DRM system, a domain can include multiple devices (e.g., wireless media devices 106 as well as other media devices 108) that each have a private key which is common to the domain. The domain can also include unique certificates associated with a DRM license for each of the multiple devices of the domain. In addition, the protected media content 120 can be bound to the domain such that a device which is a member of the domain having the domain private key and a unique certificate can perform actions on the protected media content that is bound to the domain.

In another embodiment, the key escrow service 144 can receive domain private key(s) from the domain controller 124 that controls the media devices, and the escrow service domain controller 146 can encrypt the domain private key(s) with a public escrow key to generate respective escrow domain key(s). The escrow service domain controller 146 can generate an escrow certificate 154 that includes the escrow domain key(s), and the escrow certificate 154 is stored with storage media 150 by the key escrow service. The escrow domain key(s) can be communicated back to the domain controller 124 from which the domain private key(s) were received. The domain controller 124 can then provide a domain certificate to a media device in the domain. If the domain certificate includes a private key, then the media device can decrypt and playback protected media content 120. The domain certificate provided by the domain controller 124 can include the escrow domain key(s) generated by the key escrow service and a device public key that corresponds to the media device.

If the original domain controller 124 of the domain is no longer in service, the key escrow service 144 can receive the domain certificate from a new media device that is being added to the domain, and that is requesting the domain private key(s) to access the protected media content 120 that is associated with the domain. The escrow service domain controller 146 at the key escrow service 144 can then correlate the escrow certificate 154 with the domain certificate that is received from the new device, and generate a new certificate for the new device. The new certificate can include the domain private key(s) encrypted with the escrow domain key, and include a device public key that corresponds to the new device. The new domain certificate can then be communicated to the new device to access the protected media content that is associated with the domain.

In one or more embodiments, the escrow service domain controller 146 at the key escrow service 144 can be implemented to receive the domain certificate from the new device as a redirected request from the content distributor 102. For example, the new device may initiate communication of the domain certificate to request the domain private key(s) to the content distributor 102, which may then redirect the request to the key escrow service 144. The key escrow service 144 can also be implemented to authenticate the new media device before responding to the request for the domain private key(s). The escrow service domain controller 146 can authenticate the new media device based on DRM properties received as part of the domain certificate from the new device. Authentication allows for validation of a consumer for transferability of the rights and restrictions that were part of an original purchase of protected media content.

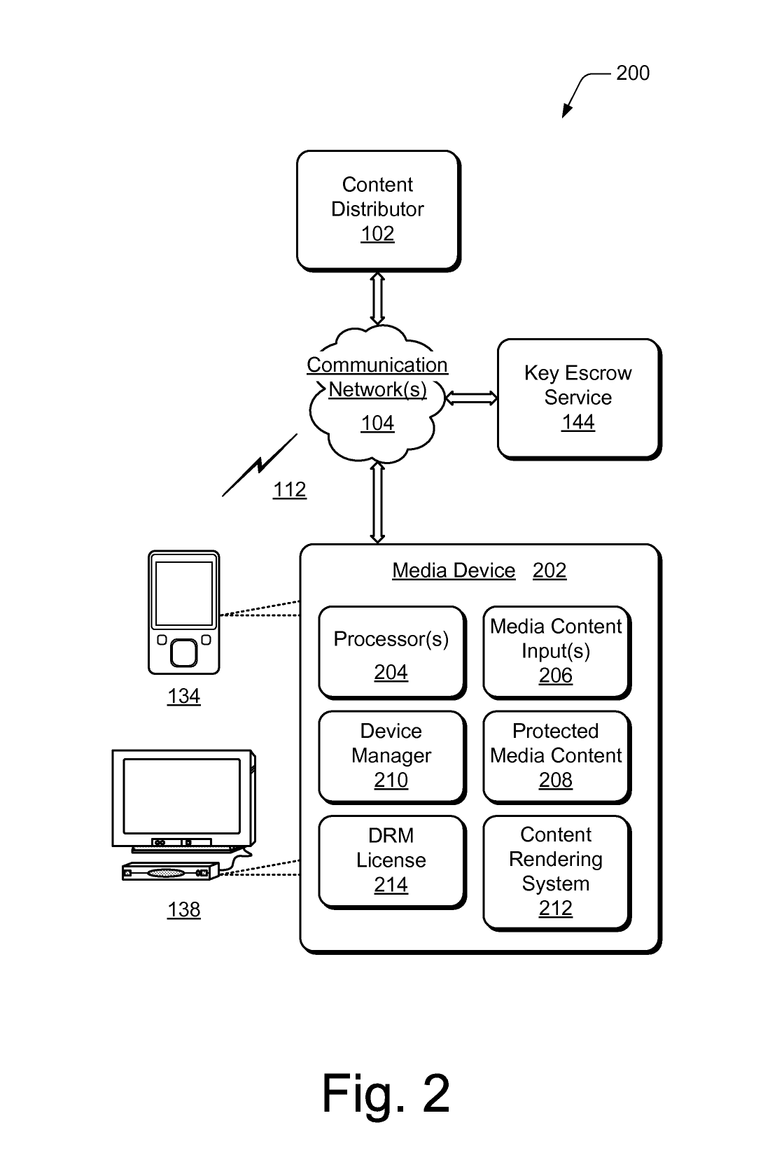

FIG. 2 illustrates an example system 200 in which various embodiments of a key escrow service can be implemented. In this example, system 200 includes the content distributor 102 and an example of a wired and/or a wireless media device 202, such as portable media device 134 and television client device 138 as described with reference to FIG. 1. System 200 also includes the key escrow service 144 which implements the various embodiments described herein. The content distributor 102, key escrow service 144, and media device 202 can all be implemented for communication with each other via the communication network(s) 104 and/or the wireless communications network 112.

Media device 202 can be implemented with processing, communication, and memory components, as well as signal processing and control circuits. Media device 202 may also be associated with a user or owner (i.e., a person) and/or an entity that operates the device such that a media device describes logical devices that include users, software, and/or a combination of devices. In this example, the media device 202 includes one or more processors 204 (e.g., any of microprocessors, controllers, and the like), media content inputs 206, and protected media content 208 (e.g., received media content, media content that is being received, recommended media content, recorded media content, etc.). The media content inputs 206 can include any type of wireless, broadcast, and/or over-the-air inputs via which media content and/or protected media content is received.

Media device 202 can also include a device manager 210 (e.g., a control application, software application, signal processing and control module, etc.) that can be implemented as computer-executable instructions and executed by the processors 204 to implement various embodiments and/or features of a key escrow service as described herein. Media device 202 can also include a content rendering system 212 to decrypt and render the protected media content 208. In addition, media device 202 can be implemented with any number and combination of differing components as further described with reference to the example device shown in FIG. 5.

Media device 202 can include a removable component that is associated with a DRM license 214 (e.g., the DRM license is cryptographically bound to the removable component). The removable component can be a token of the media device 202, and the DRM license 214 is cryptographically bound to the token of the device. The removable component can be implemented as a flash card, a Subscriber Identity Module (SIM) card, as a smart card, and/or as any other type of token of the media device 202 that is associated with the DRM license 214. The removable component can include a USIM (User Subscriber Identity Module) which is a logical entity on a card to store subscriber and/or authentication information. For example, the DRM license 214 may have various, associated license identifiers, such as a customer identifier, service identifier, and/or a domain identifier that, in any combination, authenticate the media device 202 to a domain controller and/or to a license server of a DRM system and/or key escrow service. The DRM license 214 provides the rights and restrictions of the actions performed on the protected media content 208, such as to render, playback, copy, print, execute, consume, and/or other actions on the protected media content.

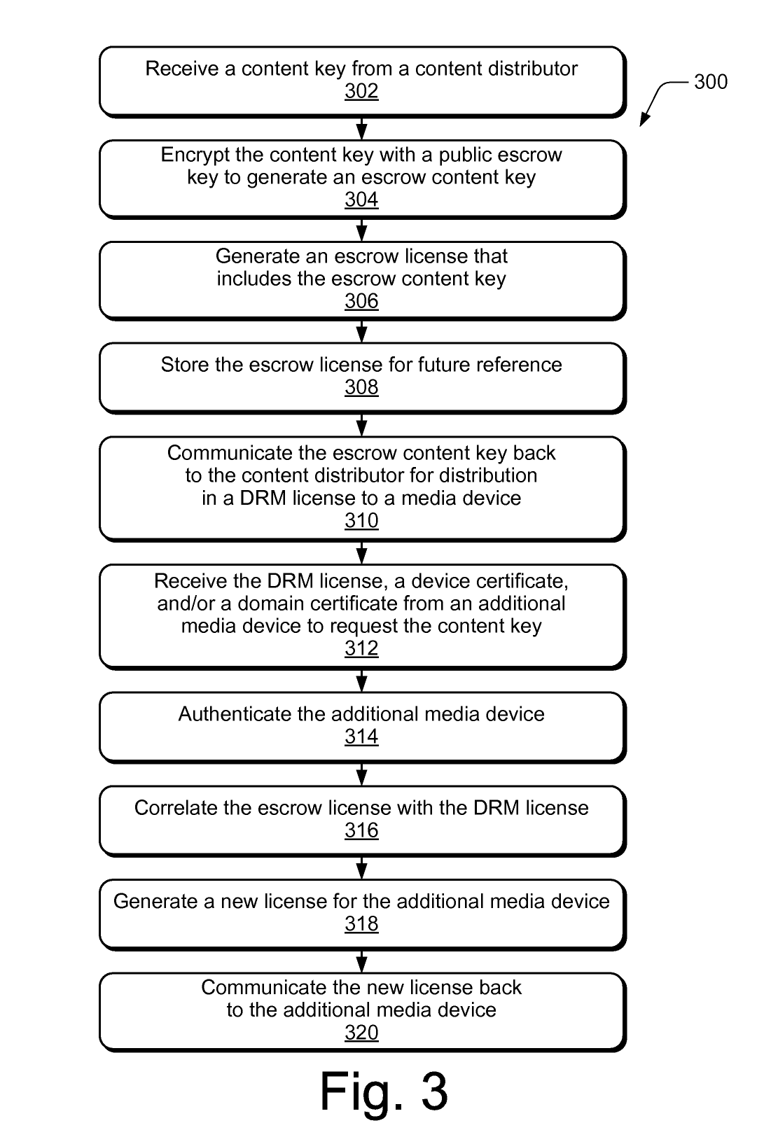

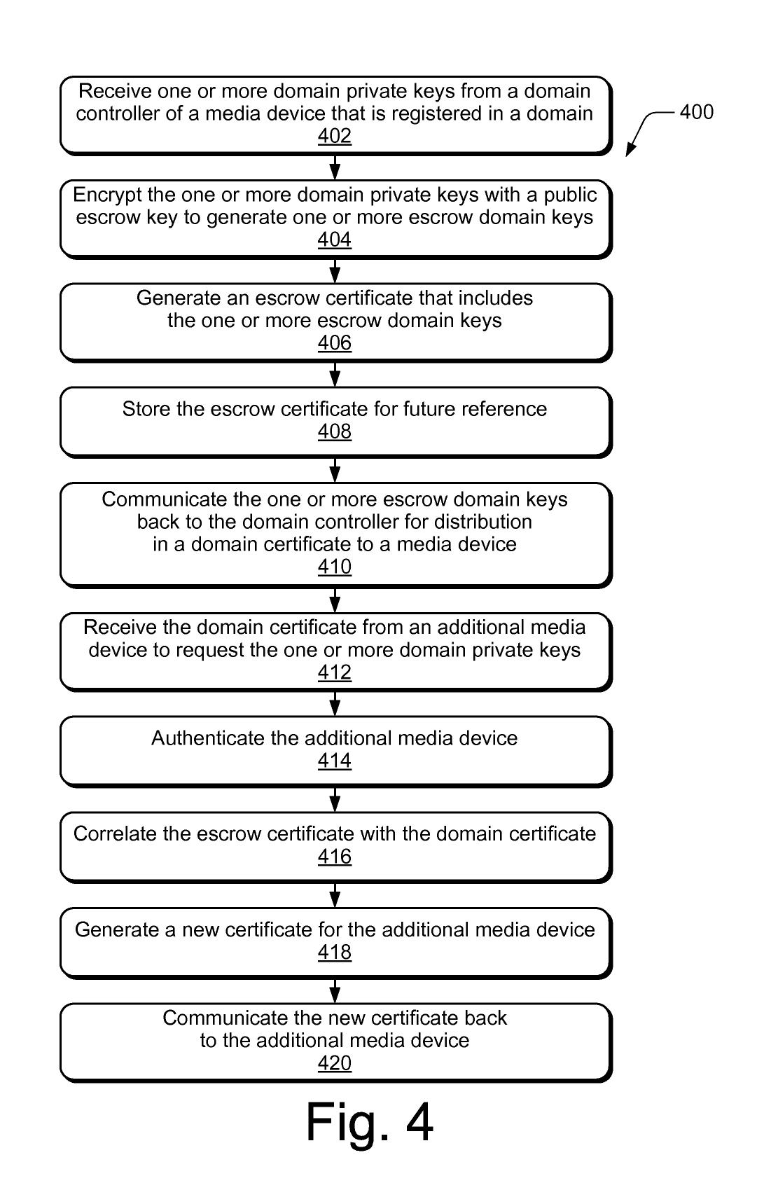

Example methods 300 and 400 are described with reference to respective FIGS. 3 and 4 in accordance with one or more embodiments of a key escrow service. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example methods 300 and 400 may be described in the general context of computer-executable instructions. Generally, computer-executable instructions can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of a key escrow service. The order in which the method is described is not intended to be construed as a limitation, and any number of the described method blocks can be combined in any order to implement the method, or an alternate method.

At block 302, a content key is received from a content distributor. For example, the key escrow service 144 (FIG. 1) receives a content key from the content distributor 102, and the content key is associated with protected media content 120 that is distributed to a media device. At block 304, the content key is encrypted with a public escrow key to generate an escrow content key, and at block 306, an escrow license is generated that includes the escrow content key. For example, the license server 148 at key escrow service 144 encrypts the content key with a public escrow key to generate an escrow content key that is included in an escrow license 152.

At block 308, the escrow license is stored for future reference. For example, the key escrow service 144 stores or otherwise maintains the escrow license 152 with storage media 150. At block 310, the escrow content key is communicated back to the content distributor for distribution in a DRM license to a media device. For example, the key escrow service 144 communicates the escrow content key to the content distributor 102 that then provides a DRM license to a media device. The DRM license includes both the escrow content key, and includes the content key encrypted with a public key that corresponds to the media device.

At block 312, the DRM license, a device certificate, and/or a domain certificate is received from an additional media device to request the content key. For example, the key escrow service 144 receives the DRM license, device certificate, and/or domain certificate from an additional media device that requests the content key to decrypt the protected media content 120 that has been acquired from the first media device. In one instance, the DRM license and/or certificates can be received from the additional media device as a redirected request from the content distributor.

At block 314, the additional media device is authenticated. For example, the license server 148 authenticates the additional media device before responding to the request for the content key, and in one instance, authenticates the additional media device based on DRM properties received as part of the DRM license. At block 316, the escrow license is correlated with the DRM license. For example, the license server 148 correlates the escrow license 152 with the DRM license that is received from the additional media device.

At block 318, a new license is generated for the additional media device. For example, the license server 148 generates a new license that includes both the content key encrypted with the escrow content key, and includes the content key encrypted with a public key that corresponds to the additional media device. At block 320, the new license is communicated back to the additional media device. For example, the key escrow service 144 communicates the new license to the media device that utilizes the new license to decrypt the protected media content with the content key.

FIG. 4 illustrates example method(s) 400 of a key escrow service. The order in which the method is described is not intended to be construed as a limitation, and any number of the described method blocks can be combined in any order to implement the method, or an alternate method.

At block 402, one or more domain private keys are received from a domain controller of a media device that is registered in a domain. For example, the key escrow service 144 (FIG. 1) receives one or more domain private keys from the domain controller 124 at content distributor 102. At block 404, the one or more domain private keys are encrypted with a public escrow key to generate one or more escrow domain keys, and at block 406, an escrow certificate is generated that includes the one or more escrow domain keys. For example, the escrow service domain controller 146 at key escrow service 144 encrypts the domain private key(s) with a public escrow key to generate the respective escrow domain key(s) that are included in an escrow certificate 154.

At block 408, the escrow certificate is stored for future reference. For example, the key escrow service 144 stores or otherwise maintains the escrow certificate 154 with storage media 150. At block 410, the one or more escrow domain keys are communicated back to the domain controller that provides a domain certificate to a media device. For example, the key escrow service 144 communicates the escrow domain key(s) to the domain controller 124 that then provides a domain certificate to a media device. The domain certificate includes the escrow domain key and a public key that corresponds to the media device.

At block 412, the domain certificate is received from an additional media device to request the one or more domain private keys. For example, the key escrow service 144 receives the domain certificate from an additional media device that requests the domain private key(s) to access the protected media content 120 that is associated with the domain. In one instance, the domain certificate can be received from the additional media device as a redirected request from the domain controller of the additional media device.

At block 414, the additional media device is authenticated. For example, the escrow service domain controller 146 authenticates the additional media device before responding to the request for the domain private key(s), and in one instance, authenticates the additional media device based on DRM properties received as part of the domain certificate. At block 416, the escrow certificate is correlated with the domain certificate. For example, the escrow service domain controller 146 correlates the escrow certificate 154 with the domain certificate that is received from the additional media device.

At block 418, a new certificate is generated for the additional media device. For example, the escrow service domain controller 146 generates a new certificate that includes the domain private key(s) encrypted with the escrow domain key, and includes a device public key that corresponds to the additional media device. At block 420, the new certificate is communicated back to the additional media device. For example, the key escrow service 144 communicates the new certificate to the media device that utilizes the new certificate to access the protected media content that is associated with the domain.

FIG. 5 illustrates various components of an example device 500 that can be implemented as any form of a communication, computing, electronic, and/or media device to implement various embodiments of a key escrow service. For example, device 500 can be implemented as a computer device, server device, media device, content distributor, and/or as a key escrow service as shown in FIG. 1 and/or FIG. 2.

Device 500 includes protected media content 502 and one or more communication interfaces 504 that can be implemented for any type of data and/or voice communication via communication network(s). Device 500 also includes one or more processors 506 (e.g., any of microprocessors, controllers, and the like) which process various computer-executable instructions to control the operation of device 500, and to implement embodiments of a key escrow service. Alternatively or in addition, device 500 can be implemented with any one or combination of hardware, firmware, or fixed logic circuitry that is implemented in connection with signal processing and control circuits which are generally identified at 508.

Device 500 also includes computer-readable media 510, such as one or more memory components, examples of which include a removable card, SIM card, random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 510 provides data storage mechanisms to store the protected media content 502, as well as various device applications 512 and any other types of information and/or data related to operational aspects of device 500. For example, an operating system 514 can be maintained as a computer application with the computer-readable media 510 and executed on the processors 506. The device applications 512 can also include a device manager 516, a DRM platform 518, and a key escrow service 520. The DRM platform 518 can implemented as a component of the device and configured to implement the DRM techniques described herein. In this example, the device applications 512 are shown as software modules and/or computer applications that can implement various embodiments of a key escrow service as described herein.

Device 500 can also include an audio, video, and/or image processing system 522 that provides audio data to an audio rendering system 524 and/or provides video or image data to an external or integrated display system 526. The audio rendering system 524 and/or the display system 526 can include any devices or components that process, display, and/or otherwise render audio, video, and image data. In an implementation, the audio rendering system 524 and/or the display system 526 can be implemented as integrated components of the example device 500. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of a key escrow service have been described in language specific to features and/or methods, it is to be understood that the subject of the appended claims is not necessarily limited to the specific features or methods described. Rather, the specific features and methods are disclosed as example implementations of a key escrow service.

1. A key escrow service, comprising:
a storage media configured to maintain an escrow license that includes an escrow content key that is associated with protected media content distributed from a content distributor to a media device;
a license server configured to:
receive a content key from the content distributor, the content key being associated with the protected media content;
encrypt the content key with a public escrow key to generate the escrow content key;
generate the escrow license that includes the escrow content key; and
communicate the escrow content key back to the content distributor that then provides a digital rights management (DRM) license to the media device, the DRM license including both the escrow content key and the content key encrypted with a public key that corresponds to the media device.

2. A key escrow service as recited in claim 1, wherein the license server is further configured to:
receive the DRM license from an additional media device that is requesting the content key to decrypt the protected media content that has been acquired from the media device;
correlate the escrow license with the DRM license;
generate a new license that includes the content key encrypted with the escrow content key and includes the content key encrypted with a public key that corresponds to the additional media device; and
communicate the new license back to the additional media device to decrypt the protected media content with the content key.

3. A key escrow service as recited in claim 2, wherein the license server is further configured to receive the DRM license from the additional media device as a redirected request from the content distributor.

4. A key escrow service as recited in claim 2, wherein the license server is further configured to authenticate the additional media device before responding to the request for the content key.

5. A key escrow service as recited in claim 4, wherein the license server is further configured to authenticate the additional media device based on DRM properties received as part of the DRM license from the additional media device.

6. A key escrow service, comprising:
a storage media configured to maintain an escrow certificate that includes one or more escrow domain keys that are associated with a media device registered in a domain;
an escrow service domain controller configured to:
receive one or more domain private keys from a domain controller of the media device;
encrypt the one or more domain private keys with a public escrow key to generate the one or more escrow domain keys;
generate the escrow certificate that includes the one or more escrow domain keys; and
communicate the one or more escrow domain keys back to the domain controller that provides a domain certificate to the media device, the domain certificate including the one or more escrow domain keys and a device public key that corresponds to the media device.

7. A key escrow service as recited in claim 6, wherein the escrow service domain controller is further configured to:
receive the domain certificate from an additional media device that is requesting the one or more domain private keys to access protected media content that is associated with the domain;
correlate the escrow certificate with the device certificate;
generate a new certificate that includes the one or more domain private keys encrypted with the escrow domain key and includes a device public key that corresponds to the additional media device; and
communicate the new certificate back to the additional media device.

8. A key escrow service as recited in claim 7, wherein the escrow service domain controller is further configured to receive the domain certificate from the additional media device as a redirected request from the domain controller of the additional media device.

9. A key escrow service as recited in claim 7, wherein the escrow service domain controller is further configured to authenticate the additional media device before responding to the request for the one or more domain private keys.

10. A key escrow service as recited in claim 9, wherein the escrow service domain controller is further configured to authenticate the additional media device based on DRM properties received as part of the device certificate from the additional media device.

11. A method, comprising:
receiving a content key from a content distributor, the content key being associated with protected media content that is distributed to a media device;
encrypting the content key with a public escrow key to generate an escrow content key;
generating an escrow license that includes the escrow content key, the escrow license being stored for future reference; and
communicating the escrow content key back to the content distributor that then provides a digital rights management (DRM) license to the media device, the DRM license including both the escrow content key and the content key encrypted with a public key that corresponds to the media device.

12. A method as recited in claim 11, further comprising:
receiving the DRM license from an additional media device that is requesting the content key to decrypt the protected media content that has been acquired from the media device;
correlating the escrow license with the DRM license;
generating a new license that includes the content key encrypted with the escrow content key and includes the content key encrypted with a public key that corresponds to the additional media device; and
communicating the new license back to the additional media device to decrypt the protected media content with the content key.

13. A method as recited in claim 12, further comprising receiving the DRM license from the additional media device as a redirected request from the content distributor.

14. A method as recited in claim 12, further comprising authenticating the additional media device before responding to the request for the content key.

15. A method as recited in claim 14, further comprising authenticating the additional media device based on DRM properties received as part of the DRM license from the additional media device.

16. A method as recited in claim 11, further comprising:
receiving one or more domain private keys from a domain controller of the media device that is registered in a domain;
encrypting the one or more domain private keys with the public escrow key to generate one or more escrow domain keys;
generating an escrow certificate that includes the one or more escrow domain keys, the escrow certificate being stored for future reference; and
communicating the one or more escrow domain keys back to the domain controller that provides a domain certificate to the media device, the domain certificate including the one or more escrow domain keys and a device public key that corresponds to the media device.

17. A method as recited in claim 16, further comprising:
receiving the domain certificate from an additional media device that is requesting the one or more domain private keys to access protected media content that is associated with the domain;
correlating the escrow certificate with the domain certificate;
generating a new certificate that includes the one or more domain private keys encrypted with the escrow domain key and includes a device public key that corresponds to the additional media device; and
communicating the new certificate back to the additional media device.

18. A method as recited in claim 17, further comprising receiving the domain certificate from the additional media device as a redirected request from the domain controller of the additional media device.

19. A method as recited in claim 17, further comprising authenticating the additional media device before responding to the request for the one or more domain private keys.

20. A method as recited in claim 19, further comprising authenticating the additional media device based on DRM properties received as part of the domain certificate from the additional media device.
